(19) United States
(12) Patent Application Publication
(10) Pub. No.: US 2013/0122912 A1
(43) Pub. Date: May 16, 2013

(54) Selective Radio Bearer

(71) Applicants: Zhiwei Qu, Shanghai (CN); Mei Dong, Shanghai (CN); Juying Gan, Shanghai (CN); Xiao Li, Shanghai (CN); Lasse Olsson, Stenungsund (SE); Chengqion Xie, Shanghai (CN)

(72) Inventors: Zhiwei Qu, Shanghai (CN); Mei Dong, Shanghai (CN); Juying Gan, Shanghai (CN); Xiao Li, Shanghai (CN); Lasse Olsson, Stenungsund (SE); Chengqion Xie, Shanghai (CN)

(73) Assignee: Telefonaktiebolaget L M Ericsson (publ), Stockholm (SE)

(21) Appl. No.: 13/609,503

(22) Filed: Sep. 11, 2012

Related U.S. Application Data
(63) Continuation of application No. PCT/CN2012/080653, filed on Aug. 20, 2012.
(60) Provisional application No. 61/558,475, filed on Nov. 11, 2011.

(51) Int. Cl. H04W 36/00

(52) U.S. Cl. 455/439

(57) ABSTRACT

This disclosure relates to a source mobility management node and a method in a source mobility management node for handling a mobility procedure moving a wireless terminal to a target system comprising a target mobility management node, the source mobility management node being configured to be operatively comprised in a cellular system. The method comprises the actions of: sending, to the target mobility management node, a communications message the communications message comprising an information element indicating that there is no active Radio Access Bearer, RAB, or Packet Flow Context, PFC, associated with a bearer context for the wireless terminal.

The present application is a continuation of international application no. PCT/CN2012/080653, filed on Aug. 20, 2012, which claims the benefit of U.S. provisional patent application No. 61/558,475, filed on Nov. 11, 2011; the present application also claims the benefit of U.S. provisional patent application No. 61/558,475, filed on Nov. 11, 2011. The above identified applications are incorporated by reference herein in their entirety.

### TECHNICAL FIELD

Exemplifying embodiments presented herein are directed towards a mobility management node, and corresponding method therein, for handling bearer contexts for a wireless terminal where the bearer contexts have no corresponding associated Radio Access Bearer (RAB) or Packet Flow Context (PFC).

### BACKGROUND

In a typical cellular system, also referred to as a wireless communications network, wireless terminals, also known as mobile stations or user equipments, communicate via a Radio Access Network (RAN) to one or more core networks. The wireless terminals can be mobile stations or user equipment units such as mobile telephones also known as “cellular” telephones, and laptops with wireless capability, e.g., mobile termination, and thus can be, for example, portable, pocket, hand-held, computer-comprised, or car-mounted mobile devices which communicate voice and/or data with radio access network.

The radio access network covers a geographical area which is divided into cell areas, with each cell area being served by a base station, e.g., a Radio Base Station (RBS), which in some networks is also called “eNodeB”, “NodeB” or “BTS” and which in this document also is referred to as a base station. A cell is a geographical area where radio coverage is provided by the radio base station equipment installed at a base station site. Each cell is identified by an identity within the local radio area, which is broadcast in the cell. The base stations communicate over the air interface operating on radio frequencies with the user equipment units within range of the base stations.

In some versions of the radio access network, several base stations are typically connected, e.g., by landlines or microwave, to a Radio Network Controller (RNC). The radio network controller, also sometimes termed a Base Station Controller (BSC), supervises and coordinates various activities of the plural base stations connected thereto. The radio network controllers are typically connected to one or more core networks. In some networks, there is also an interface between radio nodes, e.g., the X2 interface between eNodeBs in 3GPP Long Term Evolution (LTE).

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipment units. The Third Generation Partnership Project (3GPP) has undertaken to evolve further the UTRAN and GSM based radio access network technologies. Long Term Evolution (LTE) together with Evolved Packet Core (EPC) is the newest addition to the 3GPP family.

It is well known that the radio resources between a wireless terminal and a Radio Access Network are limited and that all PDP contexts (e.g. if multiple contexts involved for a particular UE) may not be actively used at the same time. So it's very radio resource-efficient to dynamically set up Radio Access Bearers (RAB) and/or Packet Flow Contexts (PFC) based on the contexts involved for a wireless terminal.

Previous solutions provided that when the user equipment (UE) sends a Service Request as a result of a paging request from the core network, the Serving GPRS Support Node (SGSN) finds the related PDP context(s) accordingly and the SGSN will only try to re-establish the needed RAB(s)/PFC(s). And once a service request to send the data packet initiated by UE, UE can optionally include the data status to indicate which PDP to require the setup of a RAB/PFC and then SGSN can accordingly require the related radio resource.

The benefit with selective service request handling is that SGSN establish the RAB(s)/PFC(s) only when there is an absolute need, therefore the scare radio resource can be saved effectively in the radio network and the UE.

### SUMMARY

The selective service request or RAB release procedure will lead to partial RABs for the UE to save the radio resource, however this may lead to two issues in S4-SGSN:
Issue#1 Handover or Serving Radio Network Subsystem (SRNS) relocation may fail for the PDP context(s)/Bearers without RAB(s) in the source RAN, and the target SGSN will then delete those PDP contexts/Bearer(s) all the way through the network. This is not the expected behavior. See below for more details:

Thus, in the Handover or SRNS relocation case, the target RNC/BSC could get the UTRAN/BSS container to have the established RAB/PFC list in the source RNC/BSC but the target SGSN will typically not know which EPS bearer context has the live RAB/PFC accordingly because the UTRAN/BSS container is transparent to the target SGSN in this respect. If there is no indication from source SGSN to target SGSN, e.g. using S16 interface, the target SGSN would like to setup the RABs/PFCs for all EPS bearer contexts; but the RNC/BSC would only setup the RABs/PFCs indicated in the UTRAN/BSS container. Then a mismatch would occur between the target RNC/BSC and target SGSN due to partial setup of RABs/PFCs in source side, the EPS bearer contexts which may not have the established the RAB/PFC would be deactivated by the target SGSN because the SGSN doesn't know whether the failure is due to no RAB/PFC in the source RNC/BSC or due to failure in RNC/BSC.
Issue#2 The 3GPP standard is not clear on how the S4SGSN should update the SGW of the bearer status when partial RAB is involved for 3G Direct Tunnel (3GDT)

Today in EPC network, for LTE, or S4SGSN without 3GDT, SGW establishes downlink user plane towards the eNodeB or towards the S4SGSN, and all the bearers for the UE are established together, or released together, i.e. there is no partial user plane setup.

There is no explicit statement from 3GPP to handle the partial user plane, which would also mean that then selective service request may not work in S4 mode, i.e. the service request can't be handled selectively.

At least some drawbacks indicated above have been eliminated or at least mitigated by an embodiment of the present solution directed to a method in a source mobility management node, for handling a mobility procedure moving a wireless terminal to a target system comprising a target mobility management node, the source mobility management node being configured to be operatively comprised in a cellular system. The method comprises the actions of sending, to the target mobility management node, a communications message the communications message comprising an information element indicating that there is no active Radio Access Bearer (RAB) or Packet Flow Context (PFC) associated with a bearer context for the wireless terminal.

At least some drawbacks indicated above have been eliminated or at least mitigated by an embodiment of the present solution directed to a source mobility management node for handling a mobility procedure moving a wireless terminal to a target system comprising a target mobility management node. The source mobility management node is configured to be operatively comprised in a cellular system. The source mobility management node comprises a transmitting port configured to transmit, to the target mobility management node, a communications message the communications message comprising an information element indicating that there is no active Radio Access Bearer, (RAB) or Packet Flow Context (PFC) associated with a bearer context for the wireless terminal.

### ABBREVIATIONS

3GDT 3G Direct Tunnel
3GPP 3rd Generation Partnership Project
BSC Base Station Controller
BSS Base Station Subsystem
CN Core Network
ECM EPS Connection Management
EMM EPS Mobility Management
EPC Evolved Packet Core
EPS Evolved Packet System
E-RAB E-UTRAN Radio Access Bearer
E-UTRAN Evolved Universal Terrestrial Radio Access Network
GGSN Gateway GPRS Support Node
GTP GPRS Tunneling Protocol
GUMMEI Globally Unique MME Identifier
GUTI Globally Unique Temporary Identity
GW Gateway
IE Information Element
IMSI International Mobile Subscriber Identity
ISD Insert Subscriber Data
MM Mobility Management
MME Mobility Management Entity
MT Mobile Terminating
NRI Network Resource Identifier
PDP Packet Data Protocol
PFC Packet Flow Context
P GW PDN Gateway
PS Packet Switched
P-TMSI Packet Temporary Mobile Subscriber Identity
RAB Radio Access Bearer
RAI Routing Area Identity
RAN Radio Access Network
RAT Radio Access Technology
RAU Routing Area Update
RNC Radio Network Controller
SGSN Serving GPRS Support Node
SGW Serving Gateway
SRNS Serving Radio Network Subsystem, the change of Iu instance and transfer of the SRNS role to another RNS.
TAI Tracking Area Identity
TAU Tracking Area Update
UE User Equipment
UMTS Universal Mobile Telecommunications System

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 shows a schematic view of a first system 100 in which some of the example embodiments may be applied,

FIG. 2 shows a schematic overview of a second system 200 in which the invention can be applied,

FIG. 3 illustrates a mobility procedure which may occur in any of the wireless systems shown in FIG. 1 or 2,

FIG. 4 is an illustrative example of a target or source mobility management node according to some of the example embodiments.

### DETAILED DESCRIPTION

In the following description, for purposes of explanation and not limitation, specific details are set forth, such as particular components, elements, techniques, etc. in order to provide a thorough understanding of the example embodiments. However, it will be apparent to one skilled in the art that the example embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

### Overview of Radio Network Systems

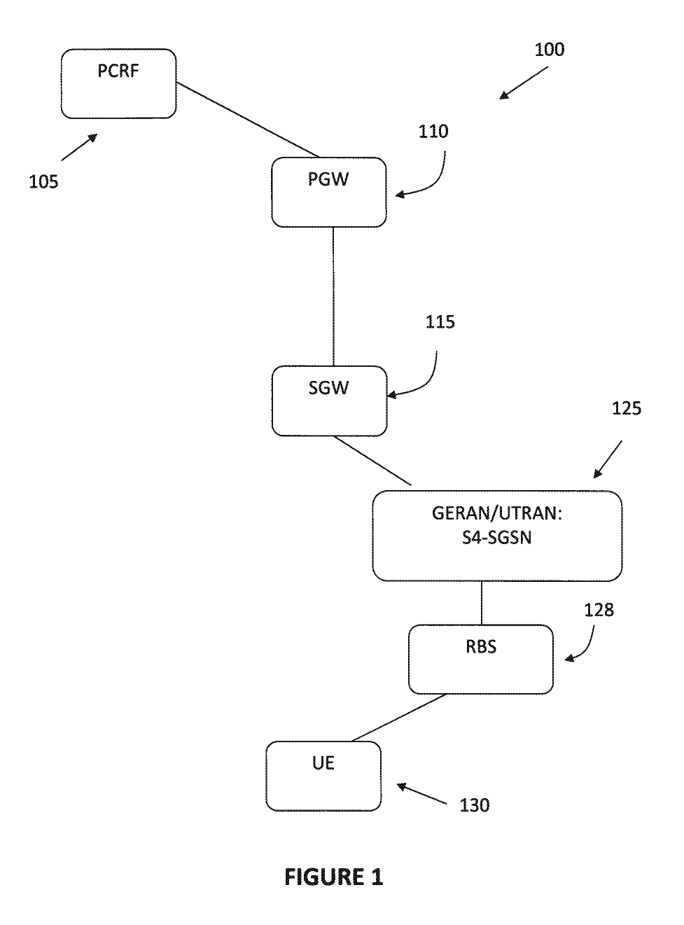

FIG. 1 shows a schematic view of a first system 100 in which some of the example embodiments may be applied. The system 100 is a so called 2G/3G system, also sometimes referred to as a GERAN/UTRAN system. As shown, the system 100 can accommodate a number of user equipments one of which is shown as an example, with the reference number 130. Naturally, the system 100 can accommodate a large number of user equipments and is not limited to accommodating only one user equipment.

All traffic to and from the user equipment 130 is routed via a so called “base station”, which, depending on the nature of the system, has different names. In the case of a GERAN/UTRAN system such as the one in FIG. 1, the base station is in this text referred to by the generic name “Radio Base Station”, here and in FIG. 1 abbreviated as RBS. The RBS which the user equipment 130 is connected to is shown in FIG. 1 as RBS 128. One example of a system specific name for an RBS is NodeB, as used in 3G systems, and another example is BTS, Base Transceiver System, as used in some 2G systems.

Regardless of the kind of system, the mobility of the user equipment 130 is controlled by what will here initially be referred to generically as a “mobility management node”, which, as shown in FIG. 1, in the case of GERAN/UTRAN is a so called S4-SGSN, shown as 125 in FIG. 1.

The “mobility management node” is connected to a Serving Gateway, an SGW 115, which in turn is connected to a PDN Gateway, PGW 110. The PGW 110 can be connected to a unit or a function for Policy and Charging Rules Function, a so called PCRF 105, or the PGW 110 can be arranged to take certain policy and charging actions on its own without the use of a PCRF.

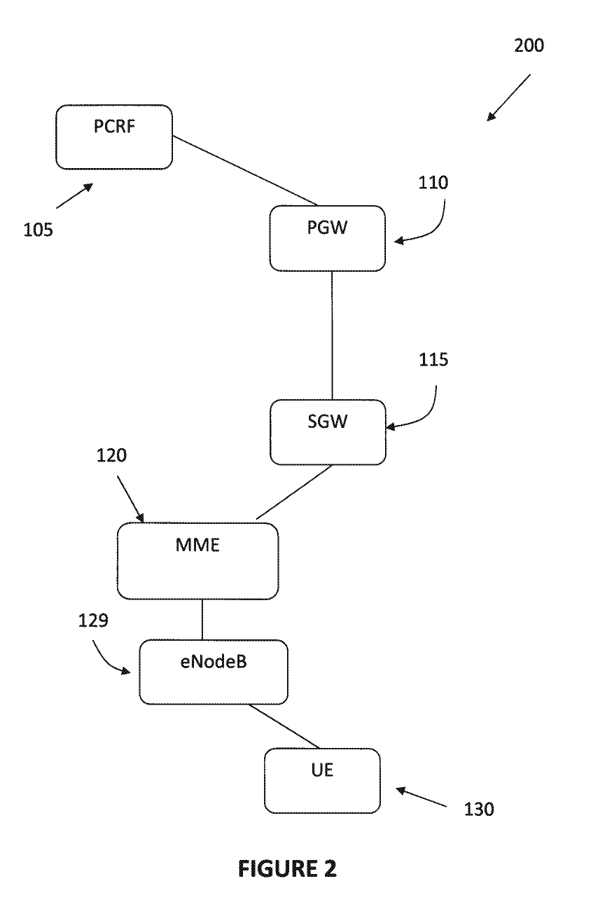

FIG. 2 shows a schematic overview of a second system 200 in which the invention can be applied. The system 200 is a so called LTE based system, also referred to as a EUTRAN system. It should be pointed out that the terms “LTE” and “LTE based” system is here used to include both present and future LTE based systems, such as, for example, advanced LTE systems.

In a EUTREAN system such as the one 200 in FIG. 2, the “base station” is referred to as an eNodeB, shown as 129 in FIG. 2. The “mobility management node” is in a EUTRAN system referred to as a Mobility Management Entity (MME) shown as 120 on FIG. 2. The SGW and PGW of the system in FIG. 2 are similar to those in FIG. 1, and will for that reason not be described again here, which is also the case for the PCRF 105.

It should be appreciated that although FIG. 1 shows a system 100 which is a GERAN/UTRAN system and FIG. 2 shows a system 200 which is an EUTRAN system, the invention can also be applied in systems which combine these two technologies, i.e. combined GERAN/UTRAN and EUTRAN systems.

### Overview of the Example Embodiments

The radio resources between a UE and a base station are limited and all PDP contexts (if multiple contexts are involved for the UE) may not be actively used at the same time. So it's very radio resource-efficient if we can dynamically set up RAB based on the contexts involved for the UE. Previous solutions provided that when the user equipment (UE) sends a Service Request as a result of a paging request from the core network, the SGSN can find the related PDP context(s) accordingly and the SGSN will only try to re-establish the needed RAB(s). And once a service request to send the data packet initiated by UE, UE can optionally include the data status to indicate which PDP to require the setup of RAB and then SGSN can accordingly require the related radio resource.

The benefit with selective service request handling is that SGSN establish the RAB(s) only when there is an absolute need, therefore the scare radio resource can be saved effectively in the radio network and the MS. However, problems arise during handover and SRNS relocation procedures.

Thus, example embodiments are presented herein to make a selective service request feature work properly no matter in SRNS relocation for S4 mode.

In 3GPP TS29.060, the solution is to add an indication per PDP context, for example:
“The Activity Status Indicator (ASI) indicates whether there is an active RAB/PFC associated with the PDP Context. This indicator is of interest when the PDP Context IE is included in a FORWARD RELOCATION REQUEST message or an inter SGSN RAU (SGSN Context Response) triggered by a Directed Signalling Connection Re-establishment.
NOTE: If the ASI indicates that there is no active RAB/PFC associated with the concerned PDP Context at the source side, no RAB/PFC needs to be set up on the target side.”

A new IE Activity Status Indicator (ASI) indicating per EPS bearer context which has a live RAB may be sent from a source SGSN to a target SGSN using S16, so that SGSN can know what RAB/PFC to reestablish.

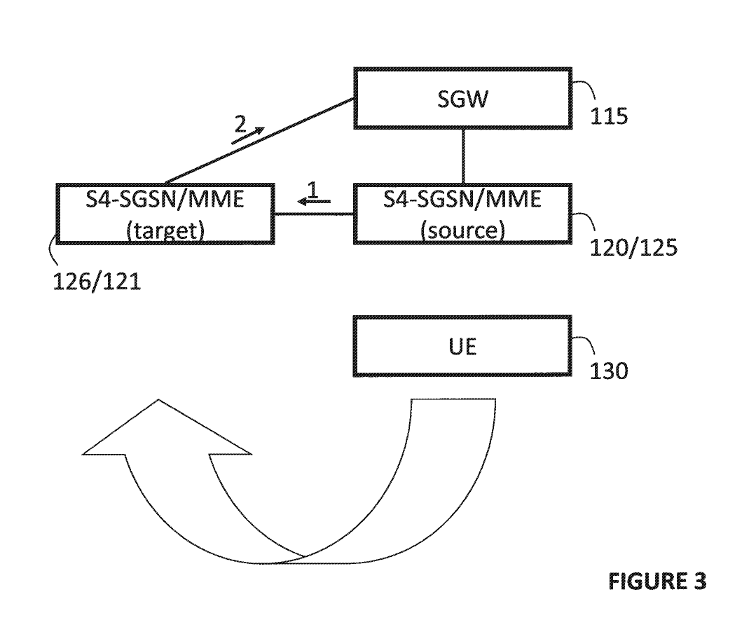

FIG. 3 illustrates a mobility procedure which may occur in any of the wireless systems shown in FIG. 1 or 2. As shown in FIG. 3, user equipment 130 may be associated with a source serving system featuring a source MME 120 or S4-SGSN 125. During a mobility procedure (e.g., a handover procedure) the user equipment 130 may move to a target system. The target system may comprise a target MME 121 or a target S4-SGSN 126.

In establishing a connection with the target system, the source MME 120 or the source S4-SGSN 125 may send a communication message to the target MME 121 or the target S4-SGSN 126 (message 1). The communication message may comprise an information element comprising an activity status indicator (ASI). The ASI may indicate whether there is an active RAB/PFC associated with the PDP context.

The target MME 121 or the target S4-SGSN 126 may also send a communication message to the SGW (message 2).

A new IE Activity Status Indicator (ASI) may be introduced into a GTPv2 message “Forward Relocation Request” and “Context Response”.

According to some of the example embodiments, the ASI may be proposed to be defined as:

Activity Status Indicator Values

| Active RAB/PFC exists | Value (Decimal) |
|---|---|
| Yes | 0 |
| No | 1 |

The impact to the GTPv2 message “Forward Relocation Request” and “Context Response” may be as provided below:

| Octet 1 | Bearer Context IE Type = 93 (decimal) | | | |
|---|---|---|---|---|
| Octets 2 and 3 | Length = n | | | |
| Octet 4 | Spare and Instance fields | | | |
| Information | | | IE | |
| elements | P | Condition/Comment | Type | Ins. |
| EPS Bearer ID | M | | EBI | 0 |
| TFT | C | This IE shall be present if a TFT is defined for this | Bearer TFT | 0 |
| | | bearer. | | |
| SGW S1/S4/S12 IP | M | | F-TEID | 0 |
| Address and TEID | | | | |
| for user plane | | | | |
| PGW S5/S8 IP | C | This IE shall be present for GTP based S5/S8 | F-TEID | 1 |
| Address and TEID | | | | |
| for user plane | | | | |
| Bearer Level QoS | M | | Bearer Level | 0 |
| | | | QoS | |
| BSS Container | CO | The MME/S4 SGSN shall include the Packet Flow | F-Container | 0 |
| | | ID, Radio Priority, SAPI, PS Handover XID | | |
| | | parameters in the TAU/RAU/Handover procedure, if | | |
| | | available. | | |
| Transaction | C | This IE shall be sent over S3/S10/S16 if the UE | TI | 0 |
| Identifier | | supports A/Gb and/or Iu mode. | | |
| Bearer Flags | CO | Applicable flags: | Bearer Flags | 0 |
| | | vSRVCC indicator: This IE shall be sent by the | | |
| | | source MME to the target MME on the S10 | | |
| | | interface if vSRVCC indicator is available in the | | |
| | | source MME. | | |
| | | ASI (Activity Status Indicator): the source S4- | | |
| | | SGSN shall set this indicator to 1 on the S16 | | |
| | | interface if the bearer context is preserved in | | |
| | | the CN without an associated RAB. | | |

See 3GPP TS29.274 v11.3.0 (2012-06) and Table 7.3.1-3: Bearer Context within MME/SGSN UE EPS PDN Connections within Forward Relocation Request

| Octet 1 | Bearer Context IE Type = 93 | | | |
|---|---|---|---|---|
| Octets 2 and 3 | Length = n | | | |
| Octet 4 | Spare and Instance fields | | | |
| Information | | | IE | |
| elements | P | Condition/Comment | Type | Ins. |
| EPS Bearer ID | M | | EBI | 0 |
| TFT | C | This IE shall be present if a TFT is defined for this | Bearer TFT | 0 |
| | | bearer. | | |
| SGW S1/S4/S12 IP | M | | F-TEID | 0 |
| Address and TEID | | | | |
| for user plane | | | | |
| PGW S5/S8 IP | C | This IE shall only be included for GTP based S5/S8. | F-TEID | 1 |
| Address and TEID | | | | |
| for user plane | | | | |
| Bearer Level QoS | M | | Bearer Level | 0 |
| | | | QoS | |
| BSS Container | CO | The MME/S4 SGSN shall include the Packet Flow | F-Container | 0 |
| | | ID, Radio Priority, SAPI, PS Handover XID | | |
| | | parameters in the TAU/RAU/Handover procedure, if | | |
| | | available. | | |
| Transaction | C | This IE shall be sent over S3/S10/S16 if the UE | TI | 0 |
| Identifier | | supports A/Gb and/or Iu mode. | | |
| Bearer Flags | CO | Applicable flags: | Bearer Flags | 0 |
| | | vSRVCC indicator: This IE shall be sent by the | | |
| | | source MME to the target MME on the S10 | | |
| | | interface if vSRVCC indicator is available in the | | |
| | | source MME. | | |
| | | ASI (Activity Status Indicator): the source S4- | | |
| | | SGSN shall set this indicator to 1 on the S16 | | |
| | | interface if the bearer context is preserved in | | |
| | | the CN without an associated RAB. | | |

Compare with 3GPP TS29.274 v11.3.0 (2012-06) and Table 7.3.6-3: Bearer Context within MME/SGSN UE EPS PDN Connections within Context Response
Bearer Flags is coded as depicted in Figure 8.32-1 of 3GPP TS29.274 v11.3.0 (2012-06).

FIG. 8.32-1: Bearer Flags

| | Bits | | | | | | | |
|---|---|---|---|---|---|---|---|---|
| Octets | 8 | 7 | 6 | 5 | 4 | 3 | 2 | 1 |

| 1 | Type = 97 (decimal) | | | | |
|---|---|---|---|---|---|
| 2 to 3 | Length = n | | | | |
| 4 | Spare | Instance | | | |
| 5 | Spare | ASI | Vind | VB | PPC |

| | |
|---|---|
| 6-(n + 4) | These octet(s) is/are present only if explicitly |
| | specified |

The following bits within Octet 5 indicate:
Bit 1—PPC (Prohibit Payload Compression): This flag is used to determine whether an SGSN should attempt to compress the payload of user data when the users asks for it to be compressed (PPC=0), or not (PPC=1).
Bit 2—VB (Voice Bearer): This flag is used to indicate a voice bearer when doing PS-to-CS SRVCC handover.
Bit 3—Vind (vSRVCC indicator): This flag is used to indicate that this bearer is an IMS video bearer and is candidate for PS-to-CS vSRVCC handover.
Bit 4—ASI (Activity Status Indicator): When set to 1, this flag indicates that the bearer context is preserved in the CN without corresponding Radio Access Bearer established. The target S4-SGSN shall keep the bearer context associated with this indicator preserved. When the target S4-SGSN sends Relocation Request message towards the target RNC, the target S4-SGSN may not request to setup the RABs for those bearer contexts associated with this indicator.

### Example Node Configuration

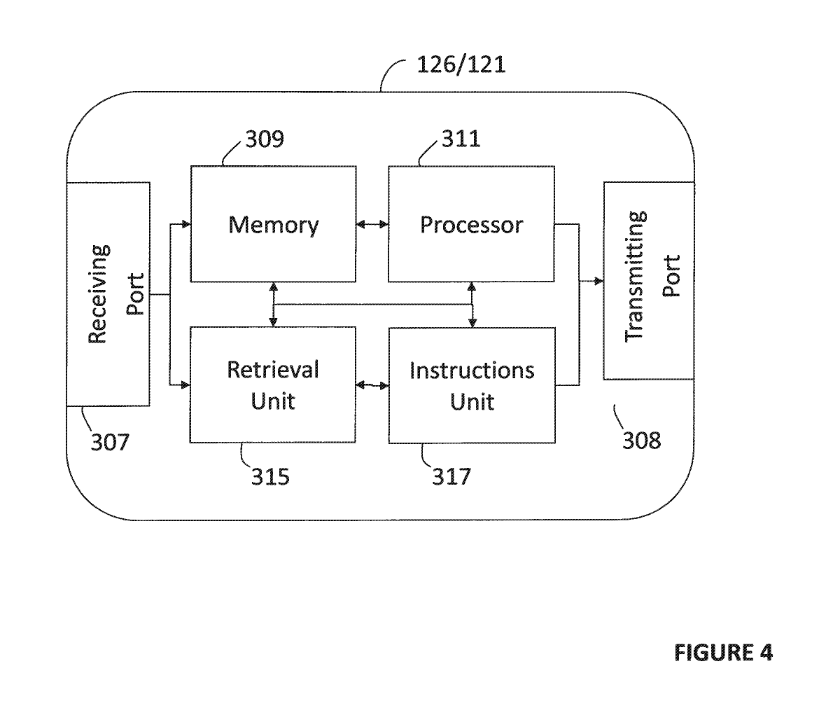

FIG. 4 is an illustrative example of a target or source mobility management node (e.g. a S4-SGSN or MME network node) according to some of the example embodiments. The network node may comprise any number of communication ports, for example a receiving port 307 and a transmitting port 308. The communication ports may be configured to receive and transmit any form of communications data. It should be appreciated that the network node may alternatively comprise a single transceiver port. It should further be appreciated that the communication or transceiver port may be in the form of any input/output communications port known in the art.

The network node may further comprise at least one memory unit 309. The memory unit 309 may be configured to store received, transmitted, and/or measured data of any kind and/or executable program instructions. The memory unit 309 be any suitable type of computer readable memory and may be of a volatile and/or non-volatile type.

The network node may also comprise a retrieval unit 315 that may be configured to retrieve an information element or any data comprised in an information element from a target and/or source system, e.g., information regarding which EPS bearer context comprises a live RAB or which RAB/PFC should be re-established. The network node may also comprise an instructions unit 317 that may be configured to provide the information element described in relation to the retrieval unit 315. The network node may further comprise a general processing unit 311.

It should be appreciated that the retrieval unit 315, the instructions unit 317 and/or the processing unit 311 may be any suitable type of computation unit, e.g. a microprocessor, digital signal processor (DSP), field programmable gate array (FPGA), or application specific integrated circuit (ASIC). It should also be appreciated that the retrieval unit 315, the instructions unit 317 and/or the processing unit 311 need not be comprised as separate units. The retrieval unit 315, the instructions unit 317 and/or the processing unit 311 may be comprised as a single computational unit or any number of units. It should further be appreciated that the retrieval unit 315, the instructions unit 317 and/or the processing unit 311 may be configured to perform any of the example embodiments described herein or any variant of the example embodiments which do not greatly depart from the scope of the example embodiments.

Some embodiments described herein may be summarized in the following manner:

One embodiment is directed to a method in a source mobility management node for handling a mobility procedure that moves a wireless terminal to a target system. The target system comprises a target mobility management node. The source mobility management node is configured to be operatively comprised in a cellular system. The method comprises the actions of sending, to the target mobility management node, a communications message the communications message comprising an information element indicating that there is no active Radio Access Bearer (RAB) or Packet Flow Context (PFC) associated with a bearer context for the wireless terminal.

The communications message may be at least one of: a Forward Relocation Request or a Context Response.

The information element may be an Activity Status Indicator (ASI).

The Activity Status Indicator (ASI) may be set to 1 if no active RAB or PFC is associated with the bearer context.

Some other embodiments described herein may be summarized in the following manner:

One embodiment is directed to a source mobility management node for handling a mobility procedure that moves a wireless terminal to a target system. The target system comprises a target mobility management node. The source mobility management node is configured to be operatively comprised in a cellular system. The source mobility management node comprises a transmitting port configured to transmit, to the target mobility management node, a communications message the communications message comprising an information element indicating that there is no active Radio Access Bearer (RAB) or Packet Flow Context (PFC) associated with a bearer context for the wireless terminal.

The communications message may be at least one of: a Forward Relocation Request or a Context Response.

The information element may be an Activity Status Indicator (ASI)

The mobility management may comprise an instructions unit 317 that is configured to provide the Activity Status Indicator (ASI) being set to 1 if no active RAB or PFC is associated with the bearer context.

### CONCLUSION

Utilizing the example embodiments presented herein various advantages may be obtained. A few non-limiting examples of such advantages may be that the example embodiments do not introduce extra signalling or messages to the existing network. The example embodiments further improve the network quality and save radio resources. The example embodiments also make it possible to only allocate the needed resources over the air interface and in the UE where resources are scarce.

It should be understood by the skilled in the art that “user equipment” is a non-limiting term which means any wireless device or node capable of receiving in DL and transmitting in UL (e.g. PDA, laptop, mobile, sensor, fixed relay, mobile relay or even a radio base station, e.g. femto base station). The example embodiments are not limited to LTE, but may apply with any RAN, single- or multi-RAT. Some other RAT examples are LTE-Advanced, UMTS, HSPA, GSM, cdma2000, HRPD, WiMAX, and WiFi.

The foregoing description of embodiments of the example embodiments, have been presented for purposes of illustration and description. The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

The various example embodiments described herein is described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method in a source mobility management node for handling a mobility procedure moving a wireless terminal to a target system comprising a target mobility management node, the source mobility management node being configured to be operatively comprised in a cellular system, the method comprising:
sending, to the target mobility management node, a communications message, the communications message comprising an information element indicating that there is no active Radio Access Bearer, RAB, or Packet Flow Context, PFC, associated with a bearer context for the wireless terminal.

2. The method according to claim 1, wherein the communications message is at least one of: a Forward Relocation Request or a Context Response.

3. The method according to claim 1, wherein the information element is an Activity Status Indicator, ASI.

4. The method according to claim 3, wherein the Activity Status Indicator, ASI, is set to 1 if no active RAB or PFC is associated with the bearer context.

5. A source mobility management node for handling a mobility procedure moving a wireless terminal to a target system comprising a target mobility management node, the source mobility management node being configured to be operatively comprised in a cellular system, the source mobility management node comprising:
a transmitting port configured to transmit, to the target mobility management node, a communications message, the communications message comprising an information element indicating that there is no active Radio Access Bearer, RAB, or Packet Flow Context, PFC, associated with a bearer context for the wireless terminal.

6. The mobility management node according to claim 5, wherein the communications message is at least one of: a Forward Relocation Request or a Context Response.

7. The mobility management node according to claim 5, wherein the information element is an Activity Status Indicator, ASI.

8. The mobility management node according to claim 7, comprising an instructions unit configured to provide the Activity Status Indicator, ASI, being set to 1 if no active RAB or PFC is associated with the bearer context.
